(19) United States
(12) Patent Application Publication
(10) Pub. No.: US 2017/0074322 A1
(43) Pub. Date: Mar. 16, 2017

(54) ROLLING BEARING

(71) Applicants: Manousos Pattakos, Nikea Piraeus (GR); John Pattakos, Nikea Piraeus (GR); Efthimios Pattakos, Nikea Piraeus (GR); Emmanouel Pattakos, Nikea Piraeus (GR)

(72) Inventors: Manousos Pattakos, Nikea Piraeus (GR); John Pattakos, Nikea Piraeus (GR); Efthimios Pattakos, Nikea Piraeus (GR); Emmanouel Pattakos, Nikea Piraeus (GR)

(21) Appl. No.: 15/260,324

(22) Filed: Sep. 9, 2016

(30) Foreign Application Priority Data
Sep. 11, 2015 (GB) 1516156.5
Sep. 15, 2015 (GB) 1516318.1
Sep. 23, 2015 (GB) 15116811.5
Oct. 5, 2015 (GB) 1517567.2

(51) Int. Cl. F16C 33/37; F16C 19/40; F16C 19/20

(52) U.S. Cl. CPC F16C 33/3713; F16C 19/20; F16C 19/40

(57) ABSTRACT

A rolling bearing wherein the conventional cage is replaced by independent spacers, one per pair of neighbor rolling elements, each spacer is disposed and trapped between neighbor rolling elements, each spacer is supported on its neighbor rolling elements and is preventing them from coming into contact with each other, each spacer comprising, preferably, a case and a number of auxiliary rolling elements, resulting in rolling bearings having higher load capacity and reduced sliding friction, also a method to improve the conventional cylindrical roller bearings, the conventional ball bearings and the conventional thrust roller bearings.

### BACKGROUND

In a rolling bearing a load is carried by placing rolling elements between raceways made on a pair of bearing rings. The relative motion of the raceways causes the rolling elements to roll with very little rolling resistance and with little sliding.

Rolling bearings generally comprise two bearing rings with integral raceways. Rolling elements are arranged between the rings and roll on the raceways. Rolling elements can be balls, cylindrical rollers, needle rollers, tapered rollers, barrel rollers etc. The rolling elements are generally guided by a cage that keeps them at a uniform distance from each other and prevents them coming into contact with each other.

For particular applications, rolling bearings with a full complement of balls, cylindrical rollers, needle rollers or tapered rollers may be used. The full complement rolling bearings have the largest possible number of rolling elements, which gives them top load carrying capacity. However, due to their kinematic conditions they cannot achieve the high speeds that are possible when a cage prevents the contact between the rolling elements.

While the cage prevents the rolling elements coming into contact with each other (reducing, this way, the friction and the wear), the cage cannot help introducing sliding friction: the rolling elements slide, as they roll, on the cage.

In applications wherein the rolling bearing undergoes, as a whole, a strong acceleration (for instance as happens in the rolling bearings at the big end and at the small end of a connecting rod of an internal combustion engine), the cage undergoes heavy inertia loads and requires proper: design, material, support and lubrication.

An object of the present invention is to provide rolling bearings with “distributed” cage. Independent sub-cages (or spacers) replace the conventional cage; each spacer is supported on/trapped between neighbor rolling elements. The different architecture offers simplicity, compactness and new possibilities. The elimination of the conventional cage frees space inside the rolling bearing for bigger rolling elements (i.e. higher load capacity); it also enables easier construction/assembly, smaller/distributed inertia loads, quieter operation etc. The dimension of the spacer, along the axis of rotation of a ball bearing, is substantially smaller than the diameter of each ball; in comparison, the cage of the conventional ball bearing has a substantially bigger dimension along the rotation axis of the ball bearing.

Another object of the present invention is to provide rolling bearings that reduce the parasitic sliding friction.

Another object of the present invention is to provide a method for improved cylindrical and ball roller bearings by the substitution of the conventional cage by independent low-friction self-aligned spacers disposed between neighbor rolling elements, preferably with each spacer comprising its own auxiliary rolling elements which, by abutting and rolling onto their neighbor main rolling elements, are preventing, on one hand, the main rolling elements from contacting each other, and are reducing, on the other hand, the overall sliding friction inside the roller bearing (which, in turn, reduces the wear and overheating, increasing the load capacity).

### BRIEF DESCRIPTION OF THE DRAWINGS

FIG. 1 shows at left a first embodiment and at right a conventional ball bearing of the “Prior Art”. Between each pair of neighboring balls it is disposed/trapped a cage, or sub-cage, or spacer (like a small tube supported on the two neighbor balls). The spacers replace the conventional cage. For the rest, the ball bearing comprises an outer bearing ring (having, a raceway at its inner side), an inner bearing ring (having at its external side a raceway) and ball rolling elements (balls) rolling on the raceways of the outer and inner bearing rings.

FIG. 2 shows what FIG. 1 with the external bearing rings removed to show more details. Each spacer has cuts giving it elasticity necessary during the assembly of the last spacer. The narrowing at the middle of each spacer is required to prevent the spacer from contacting the inner raceway. The small elasticity of the spacers is advantageous not only during assembly but also during operation. At right it is shown the conventional cage (made of two “wave shaped” parts, nailed to each other by pins at the end of the assembly).

FIG. 3 shows what FIG. 1 after the removal of all bearing rings.

FIG. 4 shows what FIG. 1 after the removal of all bearing rings and after the removal of some balls (rolling elements).

FIG. 5 shows from another viewpoint what is shown in FIG. 4 left, with an extra spacer at the center. Now it is clear how each spacer is supported on (or trapped between) a pair of neighbor balls. Each spacer is free to rotate about a line connecting the centers of its neighbor balls. When the one ball tends to approach the other, the spacer between them stops it. When a ball tends to move away from its neighbor ball, all the rest balls and spacers around the ball bearing prevent this from happening. I.e. the set of all spacers keeps the balls at a uniform distance from each other and prevents them coming into contact with each other.

FIG. 6 shows at left and in the middle, the rolling bearings of FIG. 1 with the bearing rings properly cut; the rolling bearing shown at right differs from the one shown in the middle in that it uses a 10% bigger diameter rolling elements (balls) to exploit the space occupied by the conventional cage of the prior art (shown at left). The bearing rings and the spacers have been modified properly to fit with the bigger balls.

FIG. 7 shows what FIG. 6 from a different viewpoint.

FIG. 8 shows a second embodiment. It is an axial (or thrust) ball bearing. It uses the set of balls and spacers of the first embodiment to show the direction-less architecture of the design. The set of balls abuts/rolls onto a pair of bearing washers.

FIG. 9 shows a third embodiment; the difference from the first embodiment is that a small auxiliary ball 5 trapped into each spacer and abutting/rolling onto the respective neighbor balls takes a part of the load when the one ball tends to approach the other. The main duty of the spacer is to keep the center of the small ball 5 close to the connecting the centers of the neighbor balls. In the middle of FIG. 9 it is shown magnified (×3) the spacer from various viewpoint, complete and properly cut, with and without the auxiliary ball 5.

FIG. 10 shows a fourth embodiment. It is a cylindrical roller bearing. The inner and outer bearing rings are cut to show more details. Between each pair of cylindrical rolling elements (cylindrical rollers) it is disposed/trapped a small spacer.

FIG. 11 shows the fourth embodiment from different viewpoints.

FIG. 12 shows a slice of the two bearing rings of the fourth embodiment and only two neighbor cylindrical rollers.

FIG. 13 shows what FIG. 12 from a different viewpoint.

FIG. 14 shows what FIG. 13 after the removal of the one cylindrical roller. The spacer 8 disposed/trapped between neighbor cylindrical rollers provides adequate “contact” surface, reduced friction and small mass (especially when made of low-density antifriction material), support against the centrifugal forces at high speeds (the spacer is wider towards the center of the bearing) and easy assembly.

FIG. 15 shows a fifth embodiment; it is a modified version of the fourth embodiment.

FIG. 16 shows a sixth embodiment (a modification of the fourth embodiment). The spacer 8 comprises a cage 6 and auxiliary needle rollers 5 abutting/rolling on the neighbor rollers 4.

FIG. 17 shows the sixth embodiment from another viewpoint.

FIG. 18 shows a seventh embodiment. It differs from the sixth embodiment in that the spacer uses hollowed needle rollers and a wire frame keeping from “inside” the hollowed needle rollers at a distance.

FIG. 19 shows the spacer of the seventh embodiment assembled and disassembled.

FIG. 20 shows an eighth embodiment. It differs from the first embodiment in that the spacers are not elastic (there are no slots on them). There is one master spacer comprising two threaded parts and a clip key.

FIG. 21 shows the master spacer in more details and the way the master spacer is assembled.

FIG. 22 shows what FIG. 17 with the addition of the forces acting on some crucial parts.

FIG. 23 shows the application of the method in case of ball bearings; a spacer comprising three auxiliary (small) balls and a cage is disposed/trapped between each pair of neighboring balls. The bearing rings are properly cut to show more details. At right (FIG. 23) three of the balls have been removed to show how the spacers are, and how they are arranged.

FIG. 24 shows what FIG. 23 from different viewpoints. Each spacer comprises a “triangular” cage and three auxiliary balls. One spacer is required between each pair of neighboring main balls.

FIG. 25 shows, in more details, how the two neighbor main balls of FIG. 23 cooperate with the spacer. The spacer is self-aligned; the centers of the auxiliary balls are on a plane normal to the line from the center of the one main ball to the center of its neighbor main ball.

FIG. 26 shows the “internals” of another ball roller bearing made according the same method. It is a “full complement” ball bearing wherein the distance d between neighbor balls can be as small as desirable (but not zero, to prevent the balls from coming into contact with each other). At left it is shown the balls and the spacers. The top spacer has been moved to the center of the bearing to unhide the small distance d between the external surfaces of the neighbor main balls. In the middle, the set of the balls with the spacers is shown from another viewpoint. At right, four main balls have been removed to show the spacers between the main balls.

FIG. 27 shows the spacer of FIG. 26 in more details. Each spacer comprises five auxiliary balls and a cage. When a main ball tries to approach its neighbor main ball, the spacer assembly, which is disposed/trapped between them, keeps them at a distance. The main balls push the small auxiliary balls outwards into their “nests” in the cage.

FIG. 28 shows, at left, the complete ball bearing of FIGS. 26 and 27; in the middle it shows the ball bearing from a different viewpoint with its two bearing rings properly cut; at right it shows the roller bearing from another view point, with its bearing rings properly cut and with some of the balls and of the spacers removed. The inner bearing ring is made of two pieces to allow assembly. Without the conventional cage, the bearing becomes more compact and capable for heavier loads. The diameter of the balls can be substantially larger than the width of the bearing rings.

FIG. 29 shows another application of the same method. It is an axial (or thrust) ball bearing. The set of the balls/spacers comes from the ball roller bearing of FIGS. 26 to 28 and shows its “direction-less” design. The only difference from the ball roller bearing of FIGS. 26 to 28 is that the bearing rings have been replaced by bearing washers.

### DETAILED DESCRIPTION OF THE EMBODIMENTS

In all embodiments the spacers may have a small clearance with the rolling elements (i.e. no preloading); alternatively, a preloading between spacers and rolling elements can be used (all it takes is slightly longer/wider spacers) if desirable.

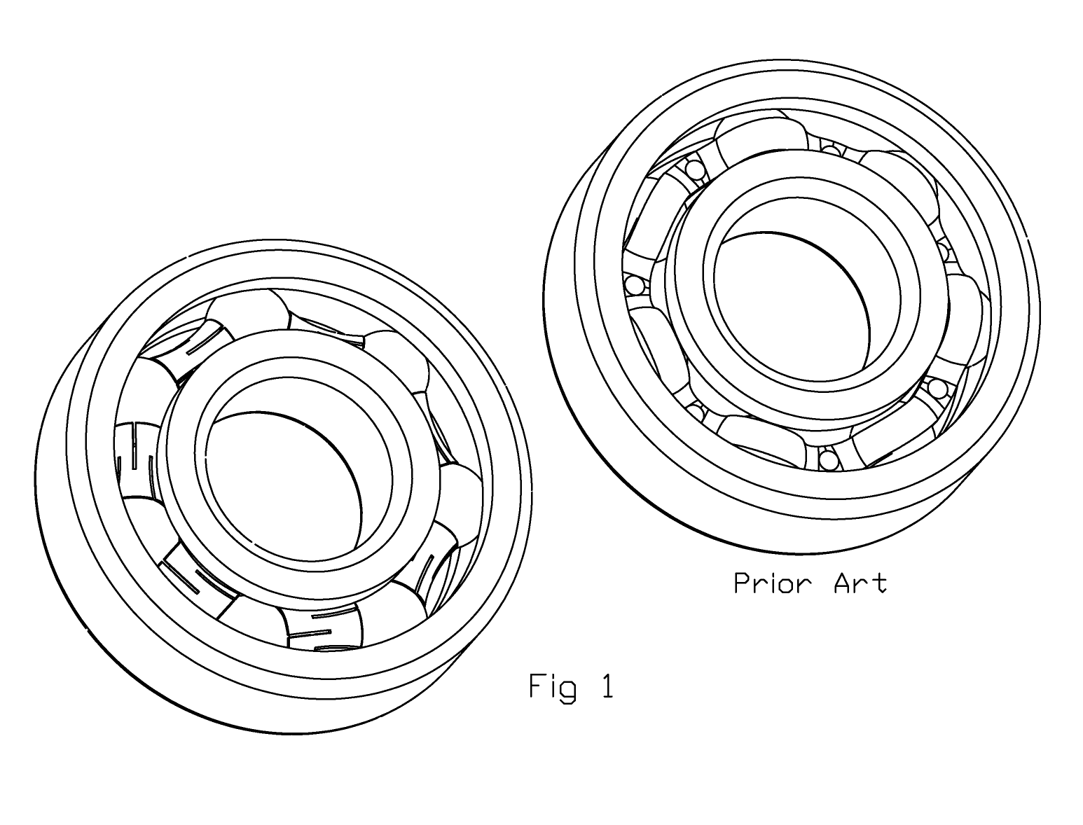

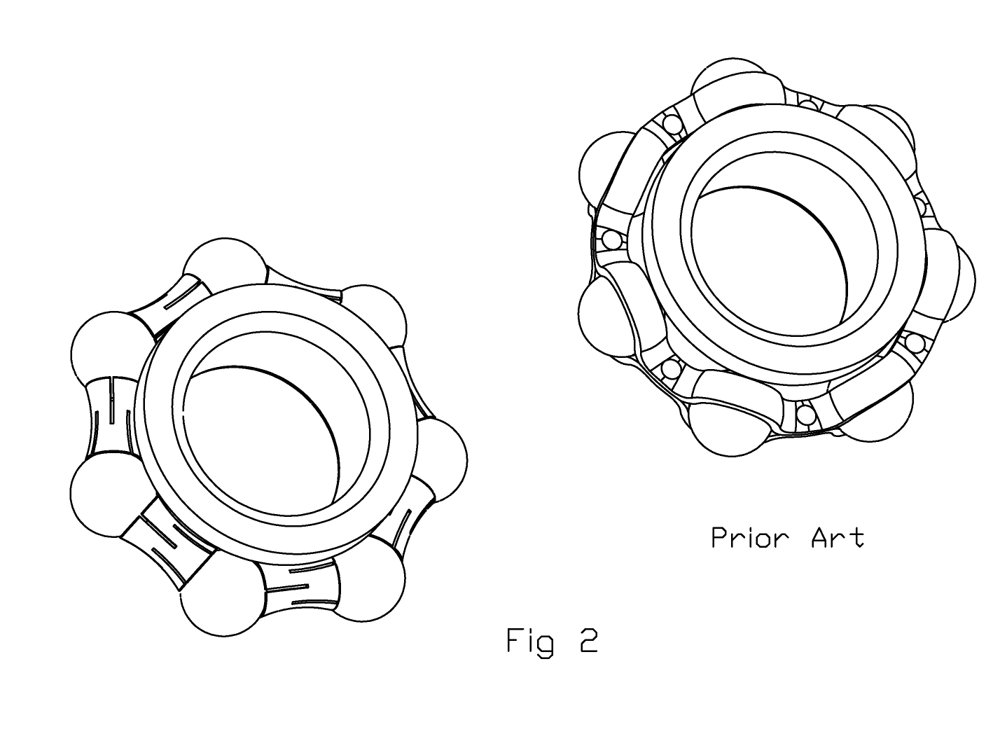

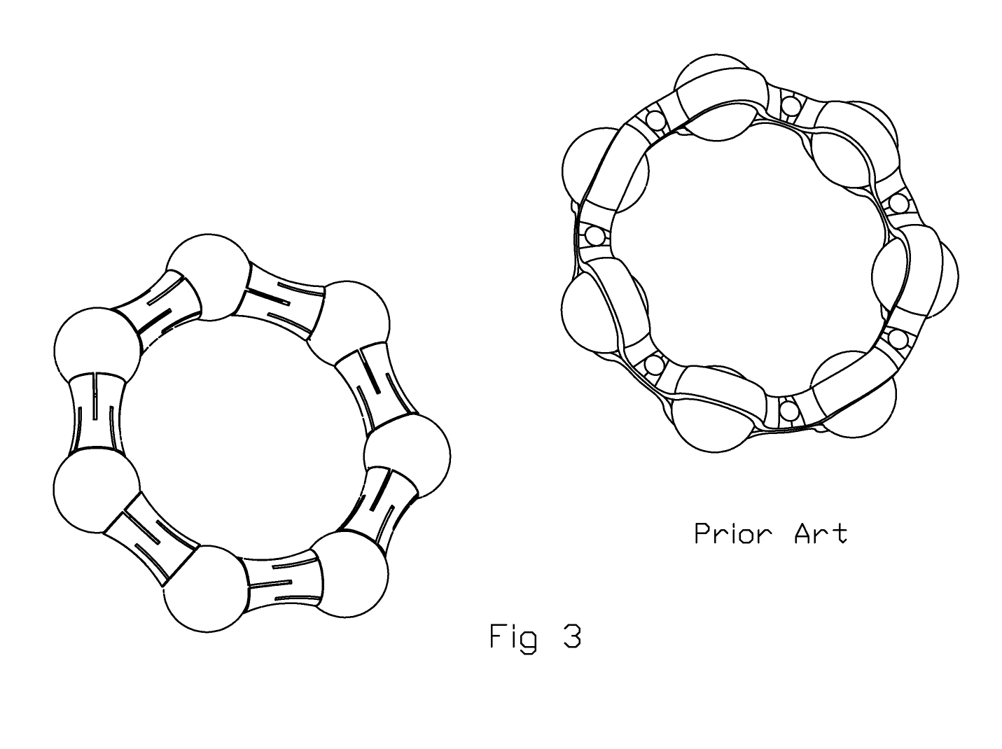

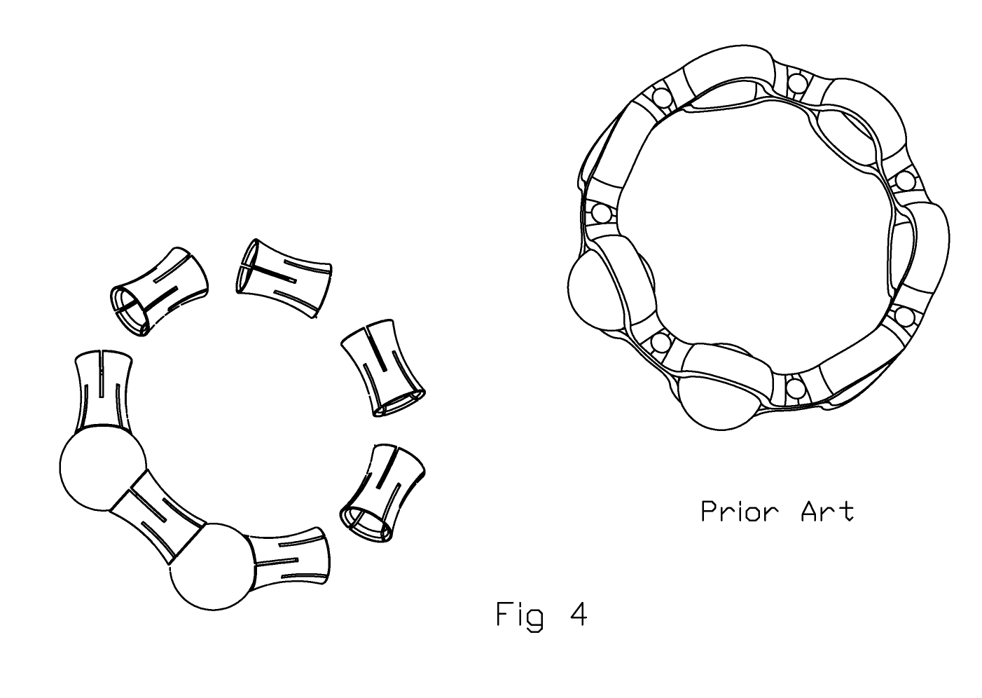

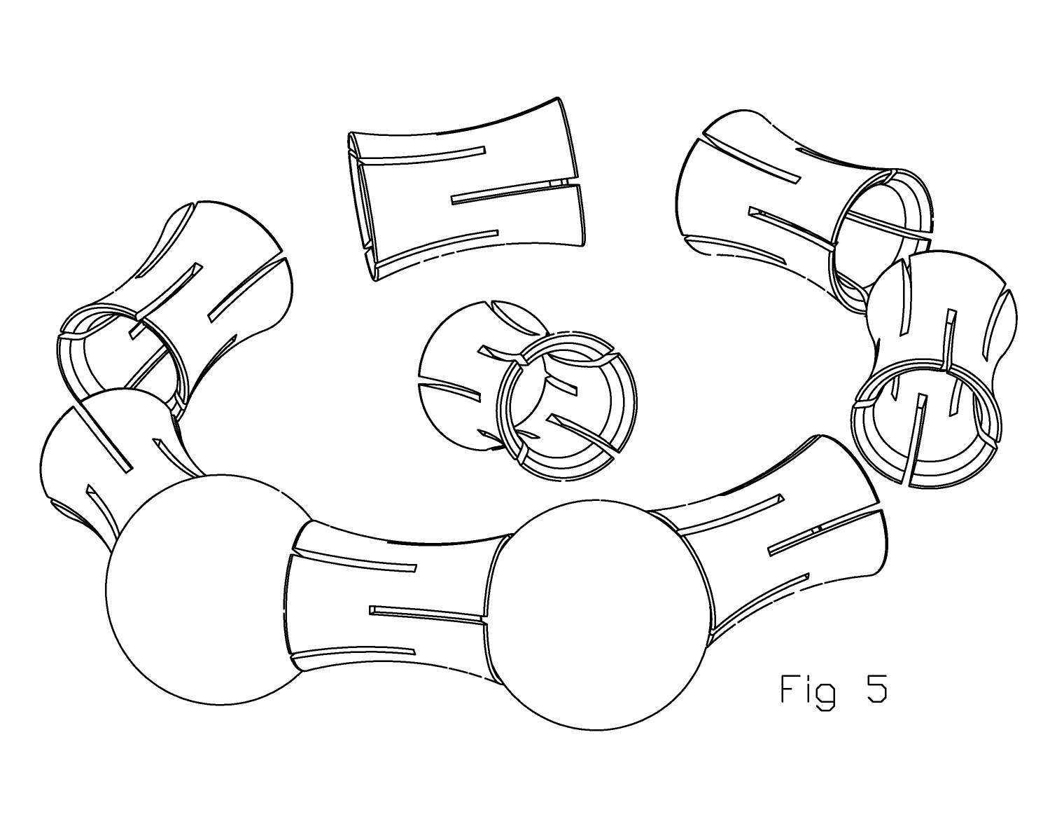

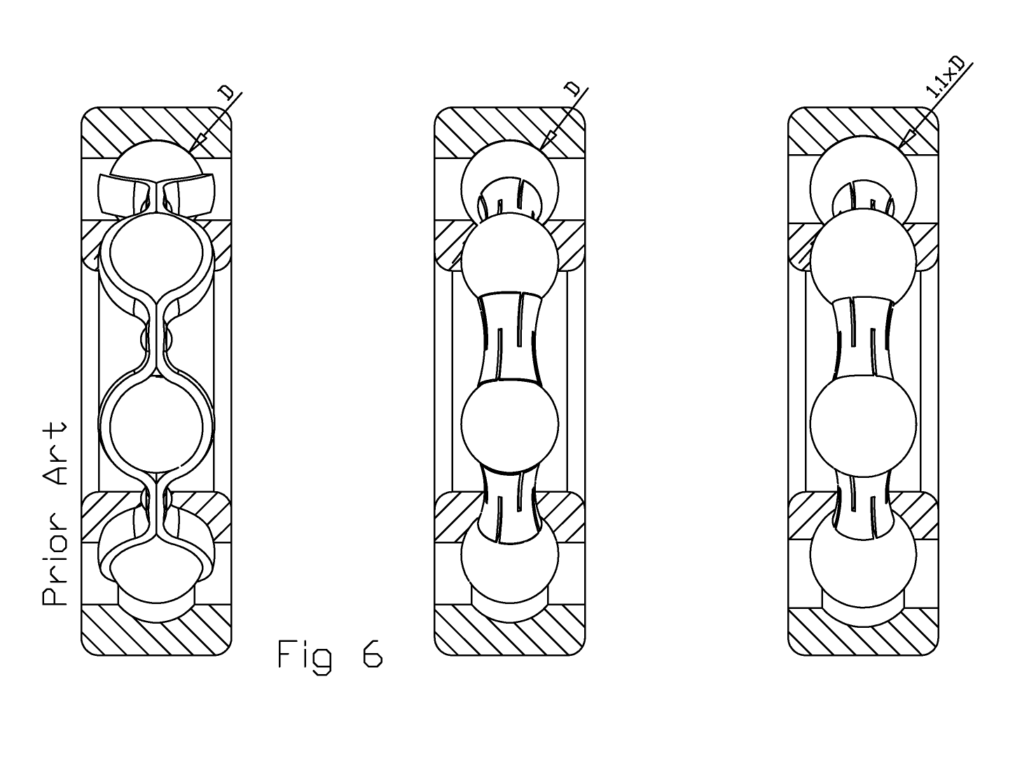

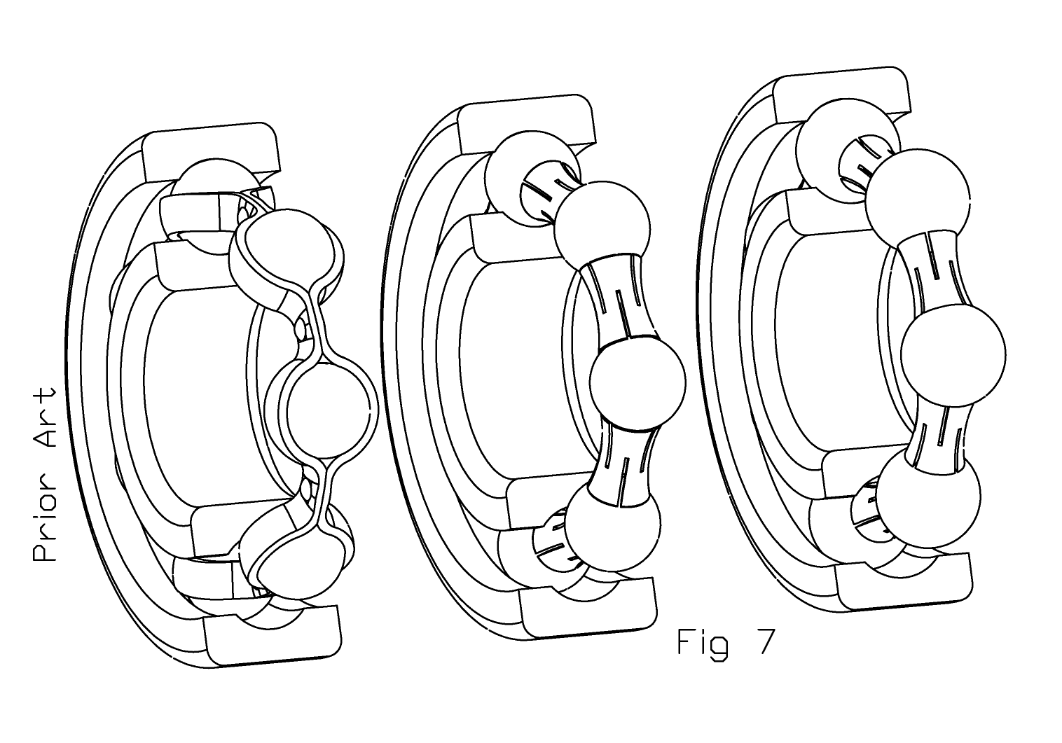

In a first embodiment, FIGS. 1 to 7, a conventional deep groove ball bearing (Prior Art) is modified according this invention. Independent spacers 8 substitute the conventional cage (which comprises two wave-shape circular strips nailed to each other at the end of the assembly). Between each pair of neighbor balls there is disposed/trapped a spacer. The neighbor balls support/hold the spacer, which needs not to contact the raceways. If a ball tends to approach a neighbor ball, the spacer between them keeps their distance at a minimum. If a ball tends to move away from a neighbor ball, the rest balls and spacers of the ball bearing keep the distance of the two neighbor balls at a maximum. I.e. the spacers keep the balls at a uniform distance from each other and prevent the balls coming into contact with each other.

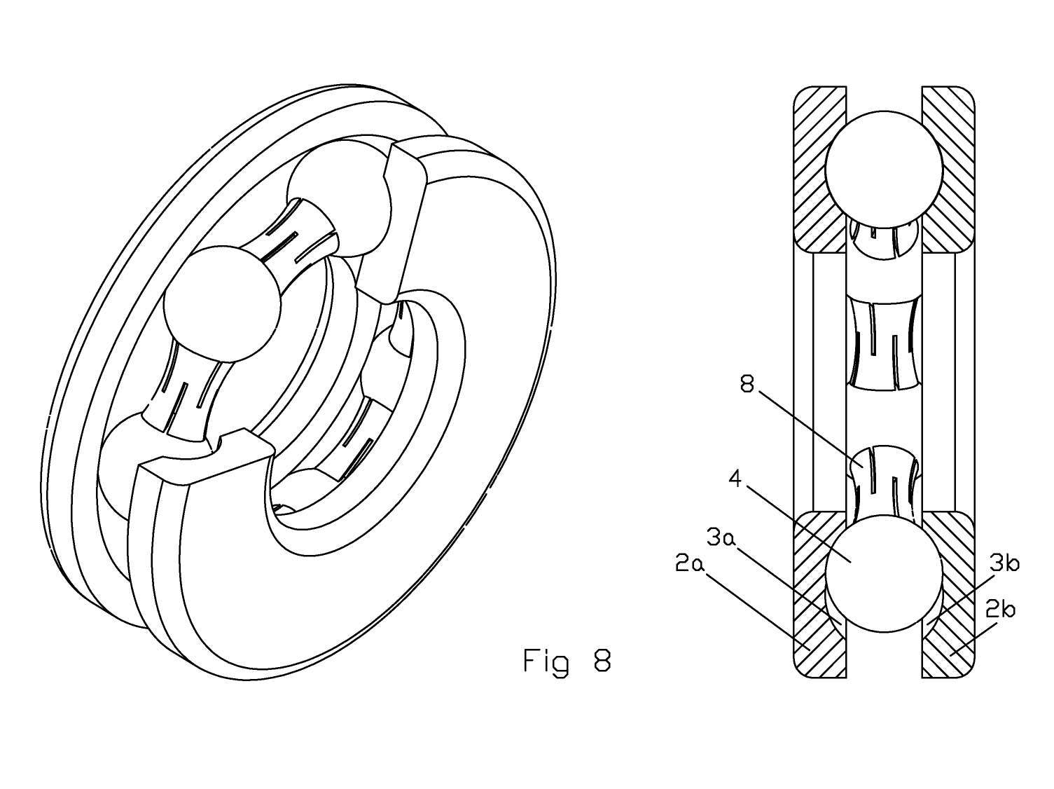

In a second embodiment, FIG. 8, a thrust (or axial roller) is using independent spacers 8 instead of a conventional cage. The balls 4 abut on the two raceways 3a and 3b, which are made on two bearing washers 2a and 2b. The spacers keep the distance between neighbor balls.

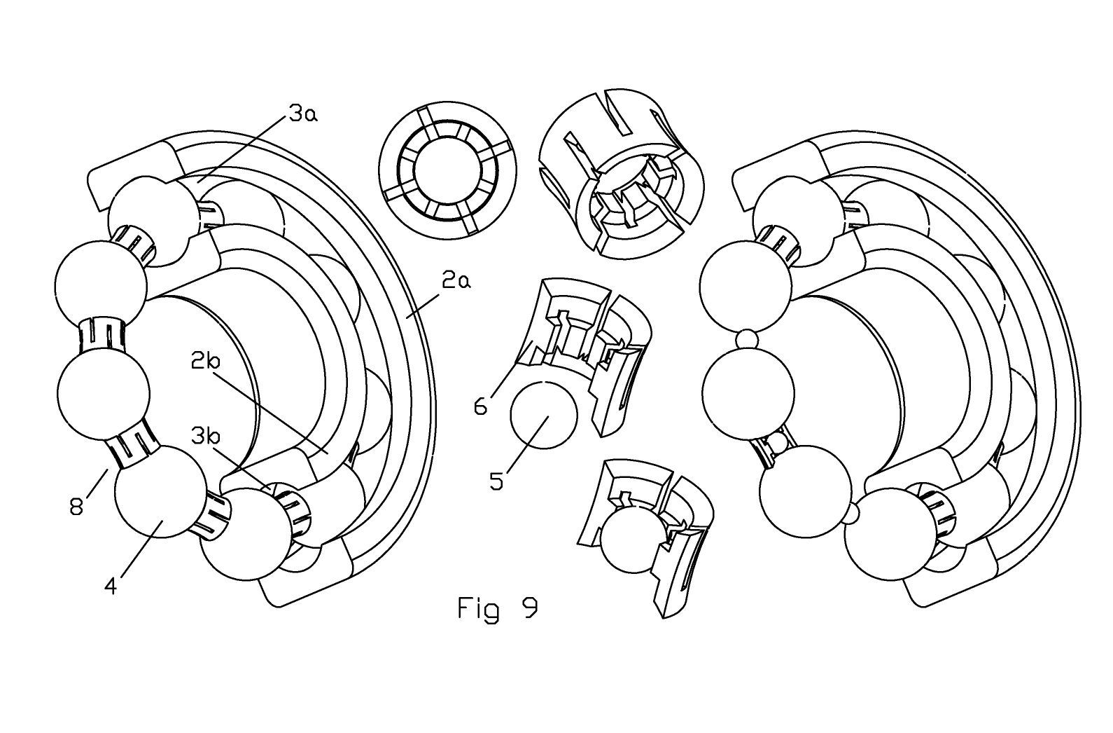

In a third embodiment, FIG. 9, an auxiliary small ball 5 is inside each spacer 8 and abuts/rolls on the two neighbor balls 4. The force required to keep the neighbor balls at a minimum distance is provided, in low friction, by the auxiliary small ball 4. The spacer 8 keeps the auxiliary ball at the right position relative to the neighbor balls.

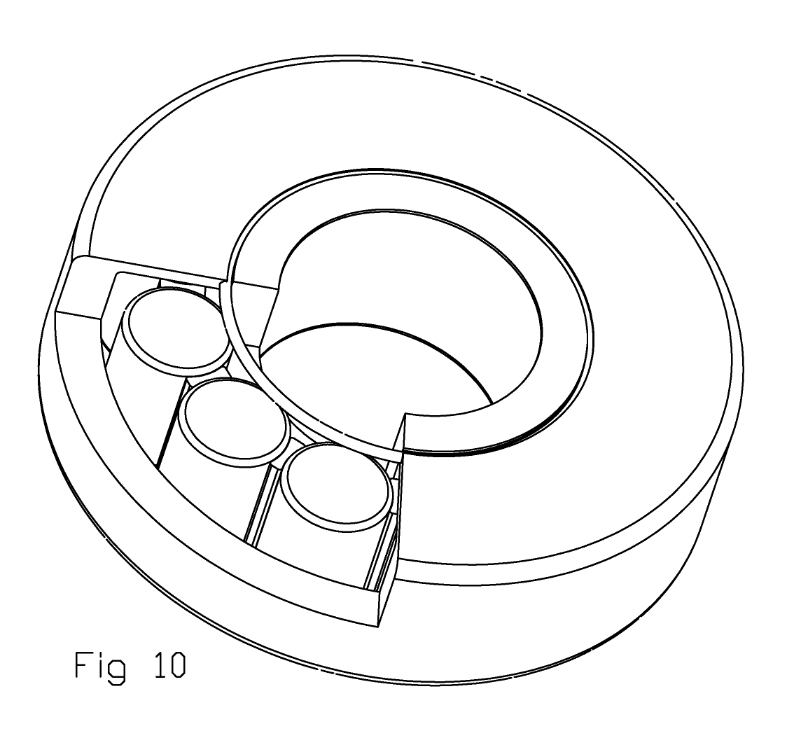

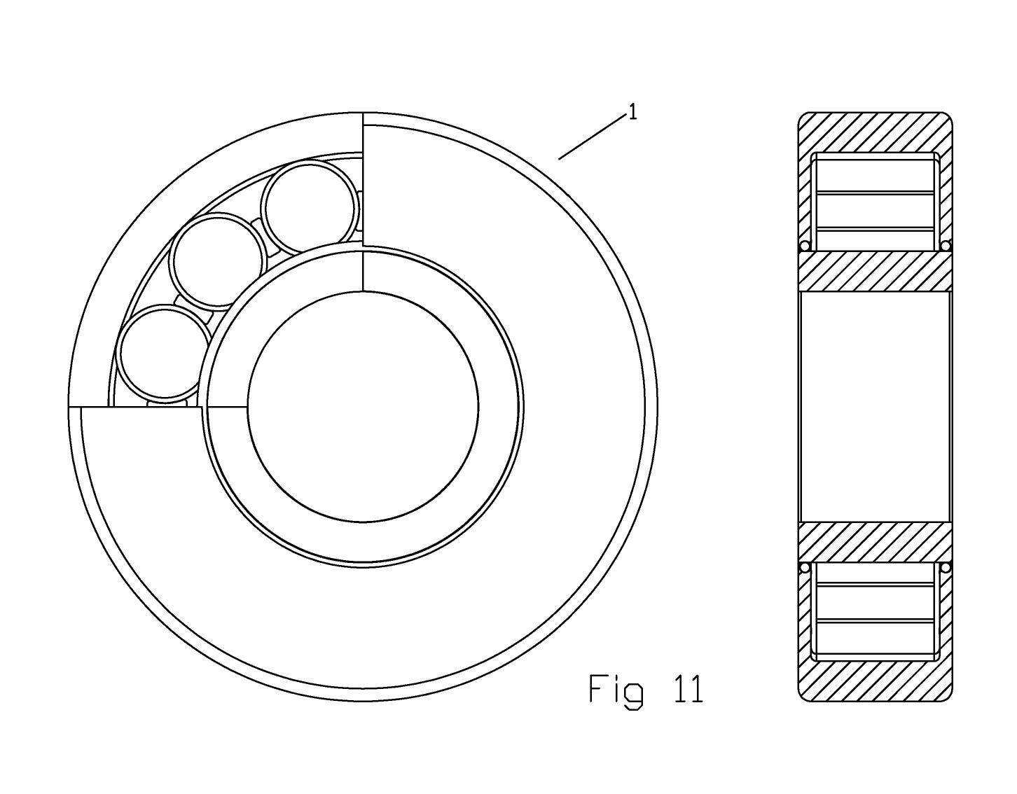

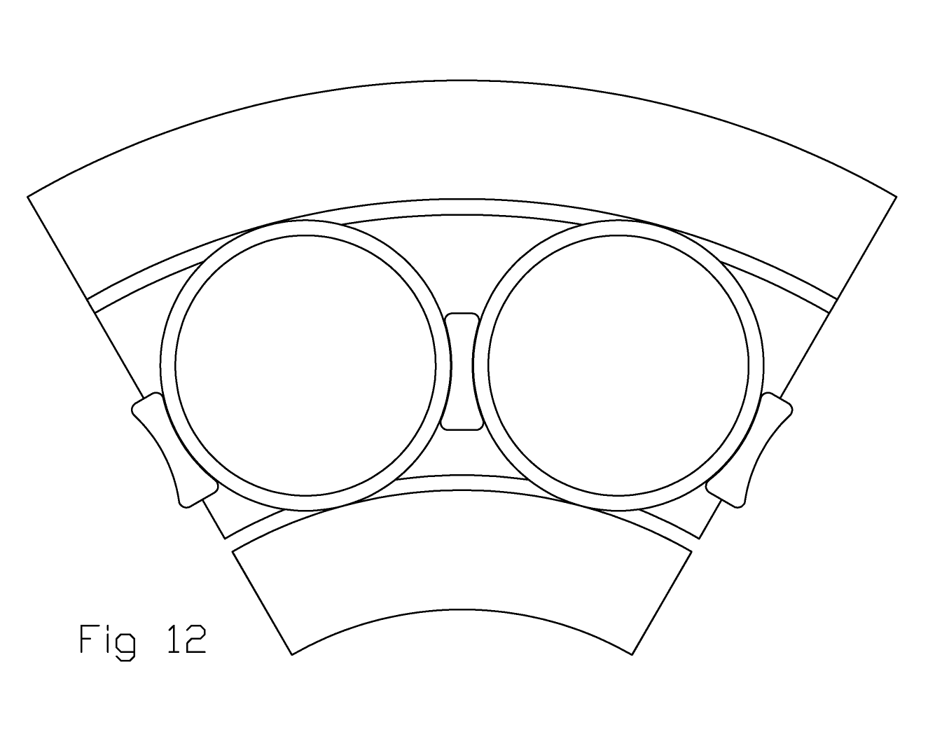

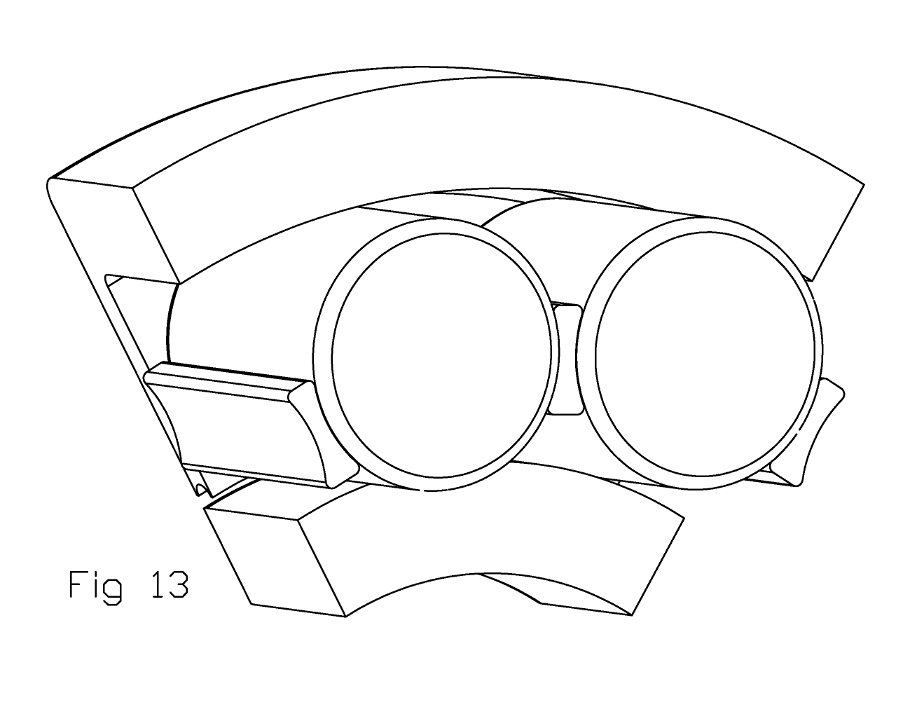

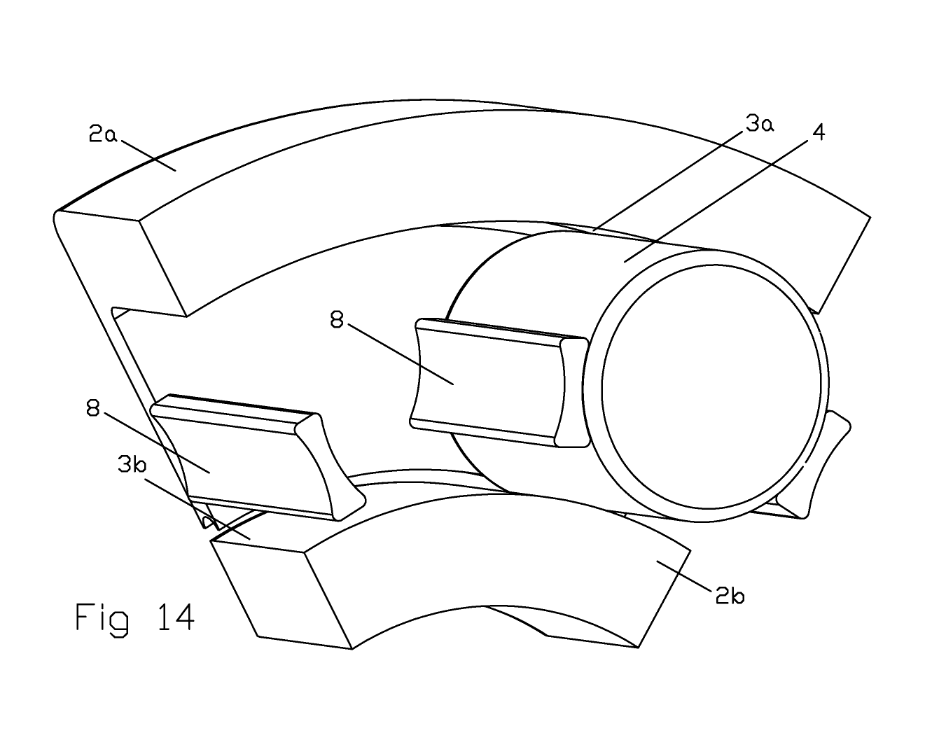

In a fourth embodiment, FIGS. 10 to 14, a cylindrical roller bearing 1 uses independent spacers 8, like pads, between neighbor cylindrical rollers 4.

It is characteristic that the sides of the external bearing ring 2a can extend till the inner ring 2b; a seal (like an O-ring in a groove of the external bearing ring 2a) can keep the lubricant inside the rolling bearing; besides eliminating the additional side covers of the conventional cylindrical roller bearing, and besides the simple manufacturing, this design improves substantially the rigidity of the external bearing ring.

It is also characteristic that the complete width of the cylindrical raceways 3a and 3b is now used to receive/transfer loads from/to the cylindrical rollers (in the conventional design the cage either extends at the sides of the cylindrical rollers or it occupies a middle part of the one raceway surface, reducing the load capacity of the cylindrical roller bearing).

The spacer 8 may seem like a wedge between two neighbor rollers; but the two neighbor rollers 4 rotate at the same direction (they both roll on the same raceway), which means the linear speeds of the two rollers 4 at their contact with the spacer 8 (at the two sides of the spacer) are opposite, which means that the spacer is receiving not a combined force that would push it along the radial direction, but a torque (pair of forces) that tends to rotate the spacer about its center.

In a fifth embodiment, FIG. 15, the spacer of the fourth embodiment has/holds an auxiliary needle roller 5 abutting/rolling on the neighbor cylindrical rollers 4. The main duty of the spacer 8 is to keep the center of the auxiliary needle roller 5 near the plane defined by the axes of its neighbor cylindrical rollers 4.

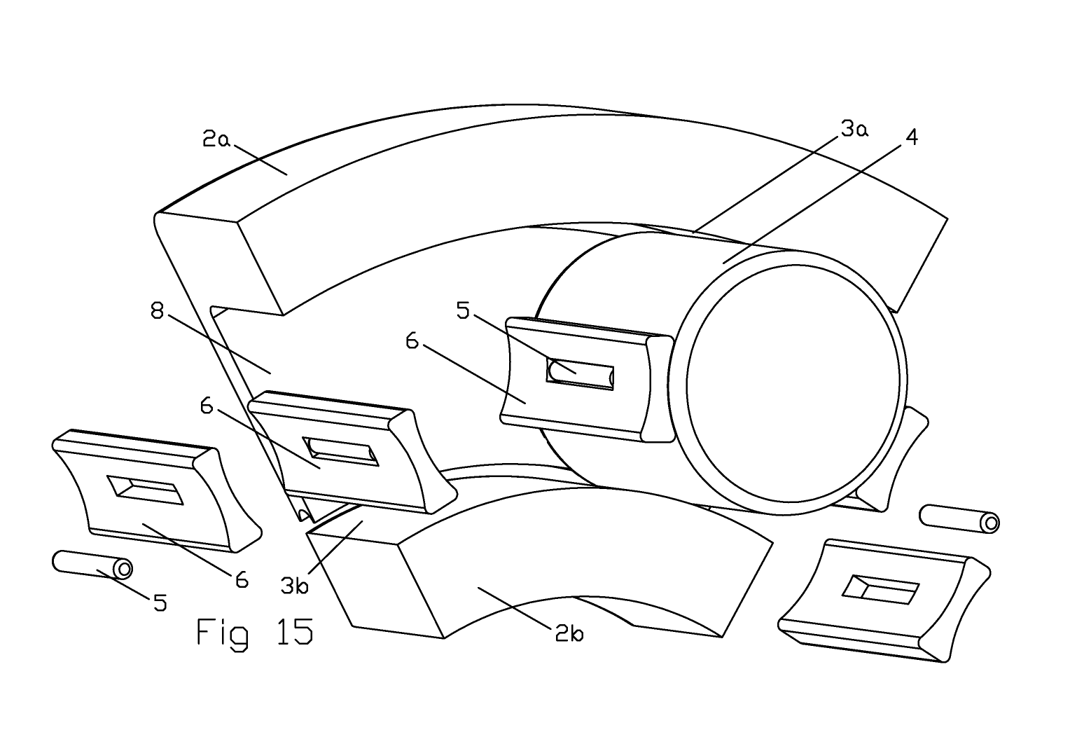

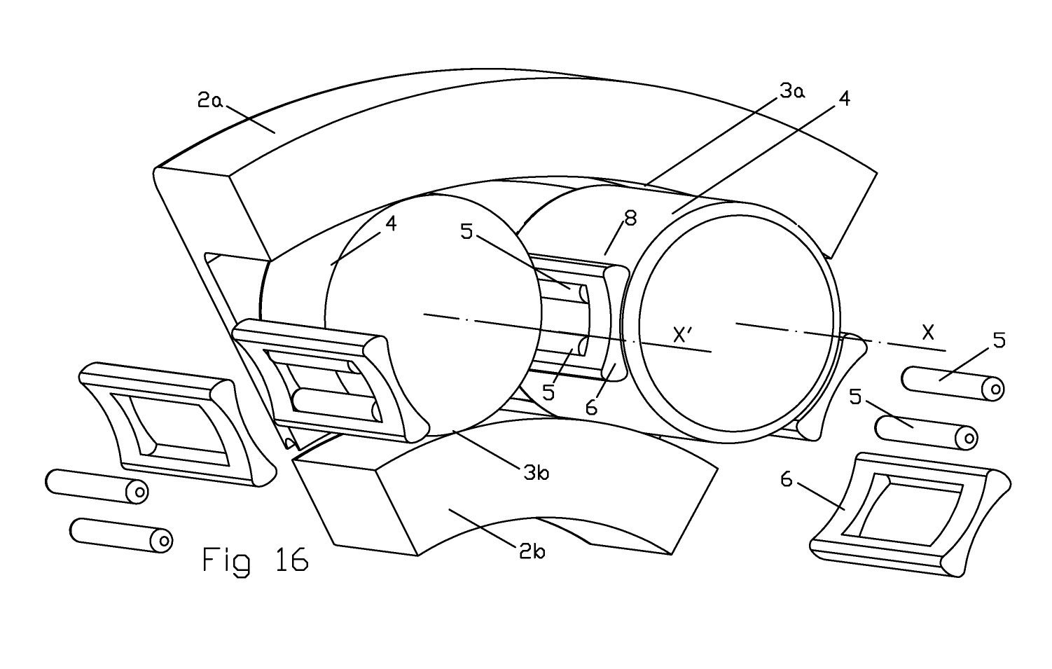

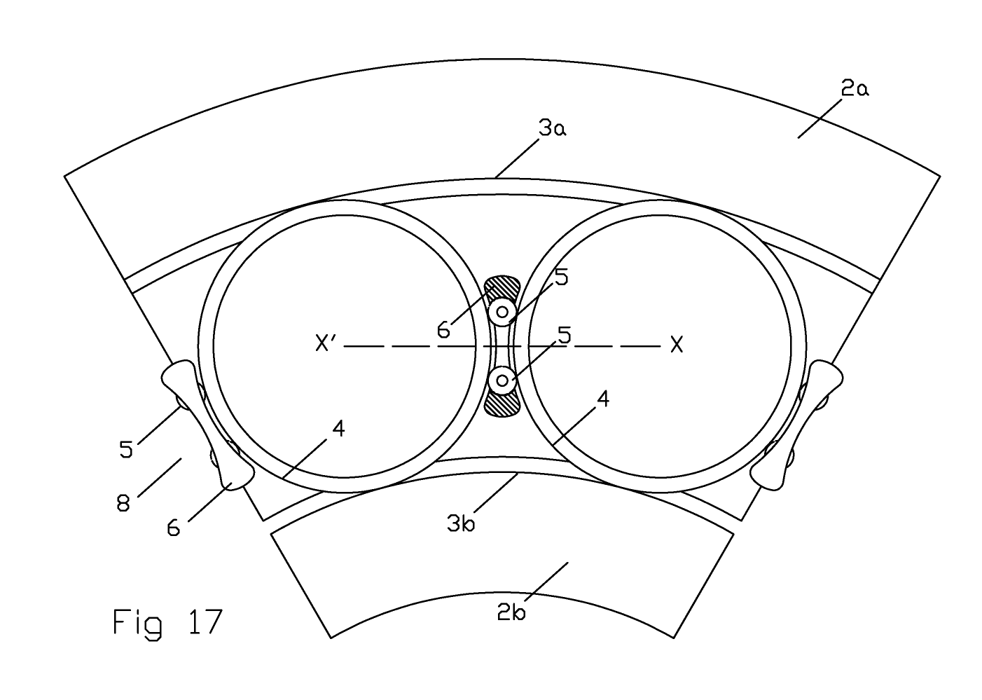

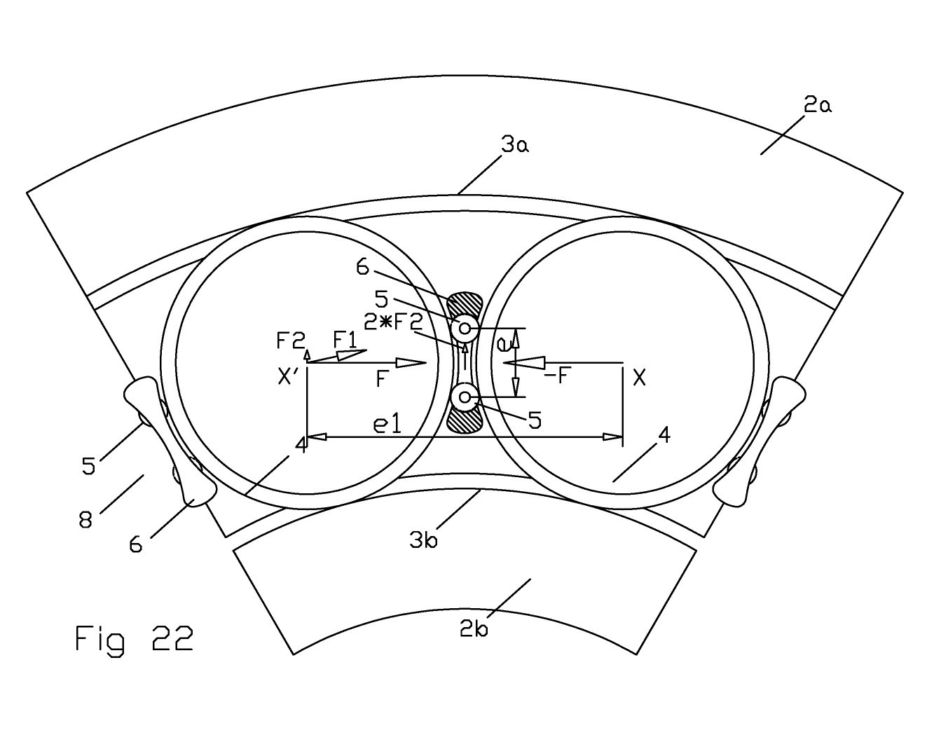

In a sixth embodiment, FIGS. 16 and 17, the cage 6 of the spacer 8 is not in contact with (i.e. it is not abutting on) its neighbor cylindrical rollers 4. The cage 6 holds two auxiliary needle rollers 5 at a “no more than a maximum” distance. Each spacer 8 is trapped between a pair of neighbor cylindrical rollers 4: the two auxiliary needle rollers (5) are disposed at opposite sides of a plane (shown by dashed line in FIG. 17) defined by the axes X, X′ of rotation of the neighbor rollers 4, so that when two neighbor cylindrical rollers 4 tend to approach each other, the two auxiliary needle rollers 5 (which are disposed between them) are pushed away from each other, with the cage 6 not allowing this to happen, so that the neighbor cylindrical rollers cannot contact with each other. The smaller the center-to-center distance (e in FIG. 22) of the two auxiliary needle rollers 5 relative to the center-to-center distance (e1 in FIG. 22) of their neighbor cylindrical rollers 4, the smaller the part of the force (2*F2 in FIG. 22) applied by the neighbor cylindrical rollers onto the auxiliary needle rollers 5 that loads the cage 6, and the smaller the resulting sliding friction.

The force F between two neighbor main rollers 4 of a conventional full complement roller bearing causes a lot of friction (and wear) because of the opposite directions, at their contact point, of the peripheral speeds of the two neighbor cylindrical rollers 4 (the relative speed doubles as compared to the relative speed between cage and roller in non full complement version). In FIG. 22 (sixth embodiment) the same force F pushing the one main roller bearing 4 towards its neighbor main roller bearing 4 results in a force 2*F2 pushing each auxiliary roller 5 onto the cage 6. In the specific case shown in FIG. 22, this 2*F2 force is some 5 times smaller than the initial force F, the relative speed between the cage 6 and the auxiliary roller 5 is half than the relative speed in the contact point of the two neighbor rollers 4 in the full complement arrangement of the previous paragraph; besides, the shape of the “nest” in the cage 6 wherein the auxiliary roller 5 is supported improves the lubrication and reduces the wear. According the previous analysis, with the auxiliary rolling elements 5 preventing the direct contact between the neighbor main rolling elements 4, the overall friction (i.e. the sliding friction) and wear reduces several times. The cage 6 needs not to contact the main rolling elements. The cage 6 needs not raceways to abut on keeping the rolling bearing simple, cheap and compact. The auxiliary rolling elements 5 need not raceways to abut on. Each cage (6) is radially supported exclusively by its respective rolling elements (5), each auxiliary rolling elements (5) is radially supported exclusively by its neighbor rolling elements (4) and its cage (6).

The previous constitute also a method for making/designing improved rolling bearings using independent low-friction self-aligned spacers disposed/trapped between neighbor rolling elements, preferably with each spacer comprising its own auxiliary rolling elements which, by abutting and rolling onto their neighbor main rolling elements, are preventing the main rolling elements from contacting each other, and are reducing the overall sliding friction inside the rolling bearing (which, in turn, reduces the wear and overheating which, in turn, increasing the load capacity).

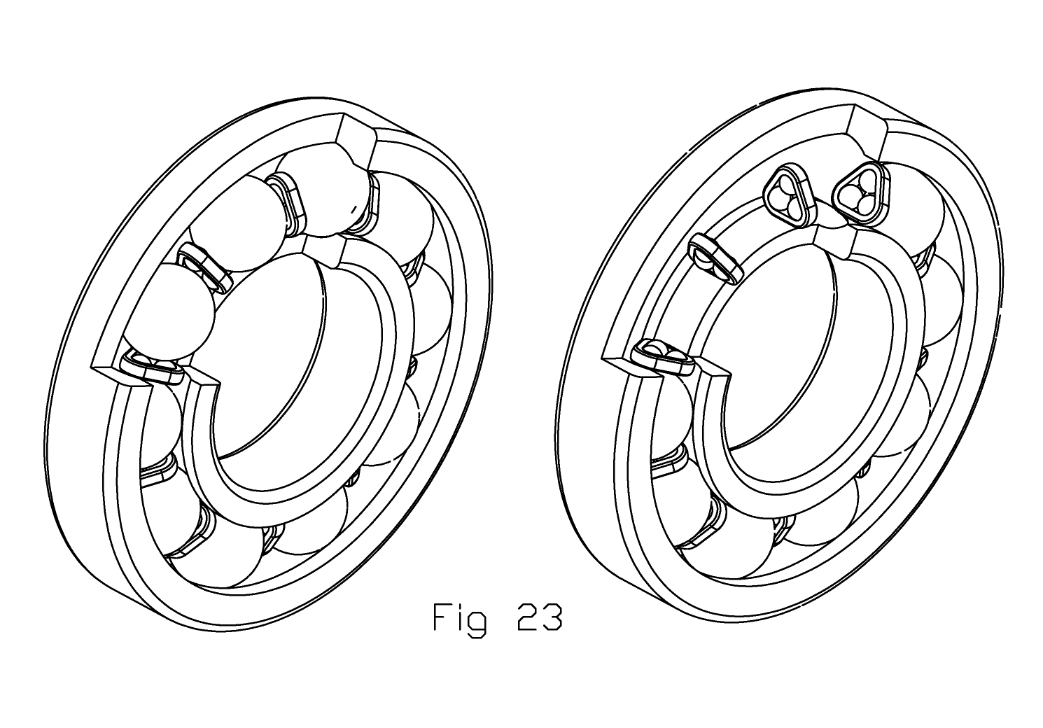

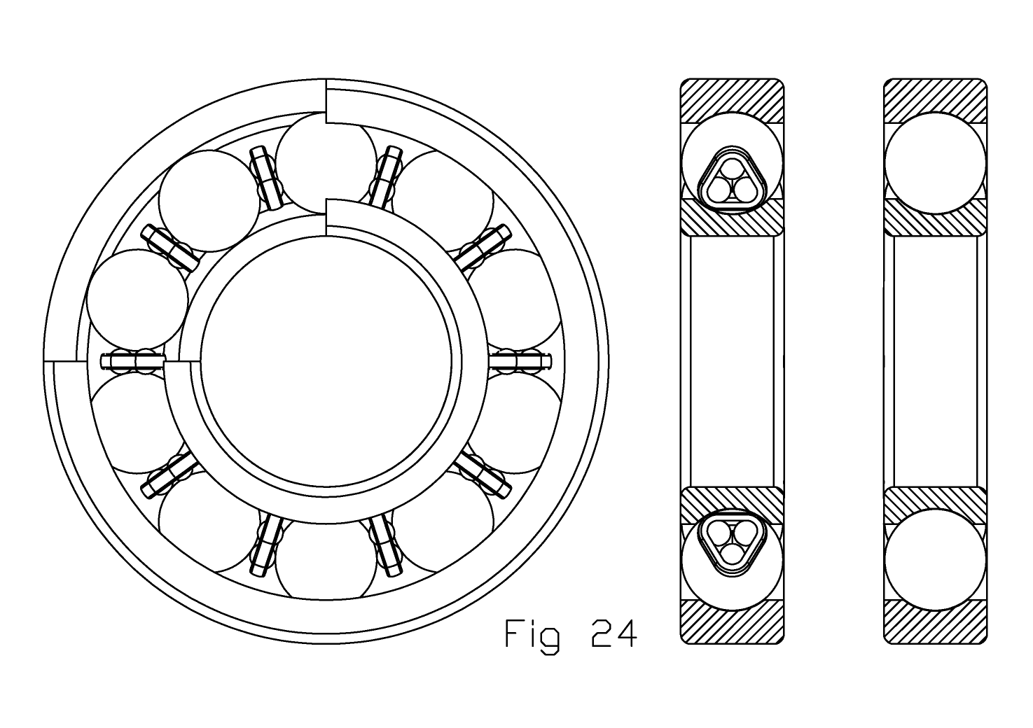

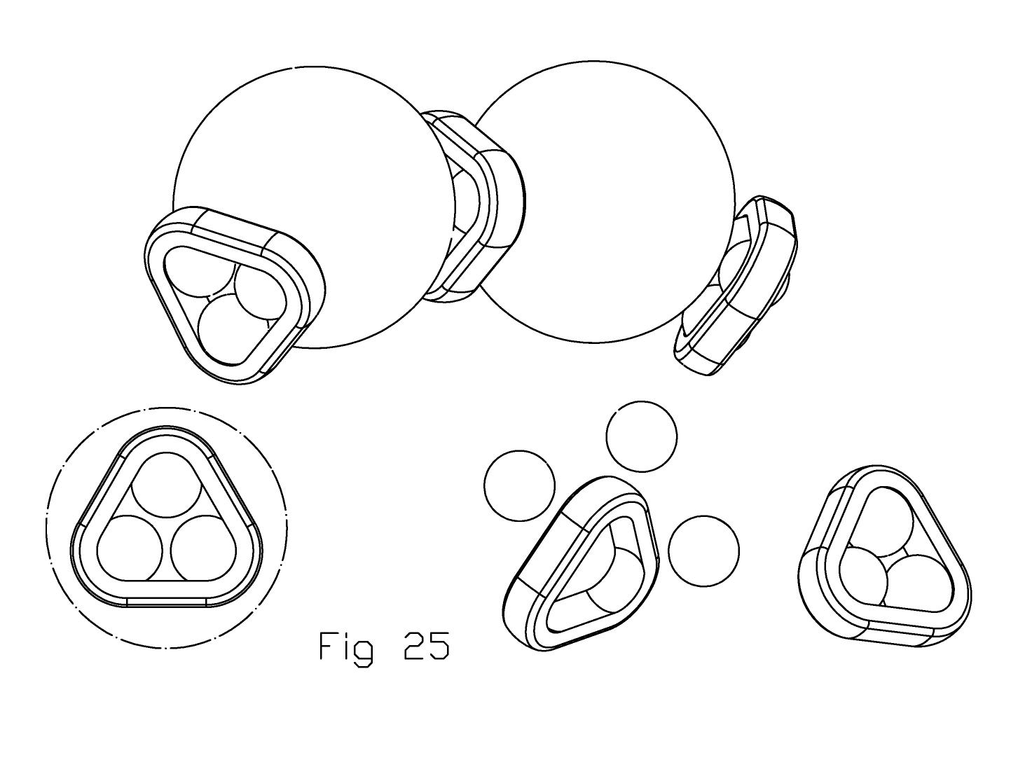

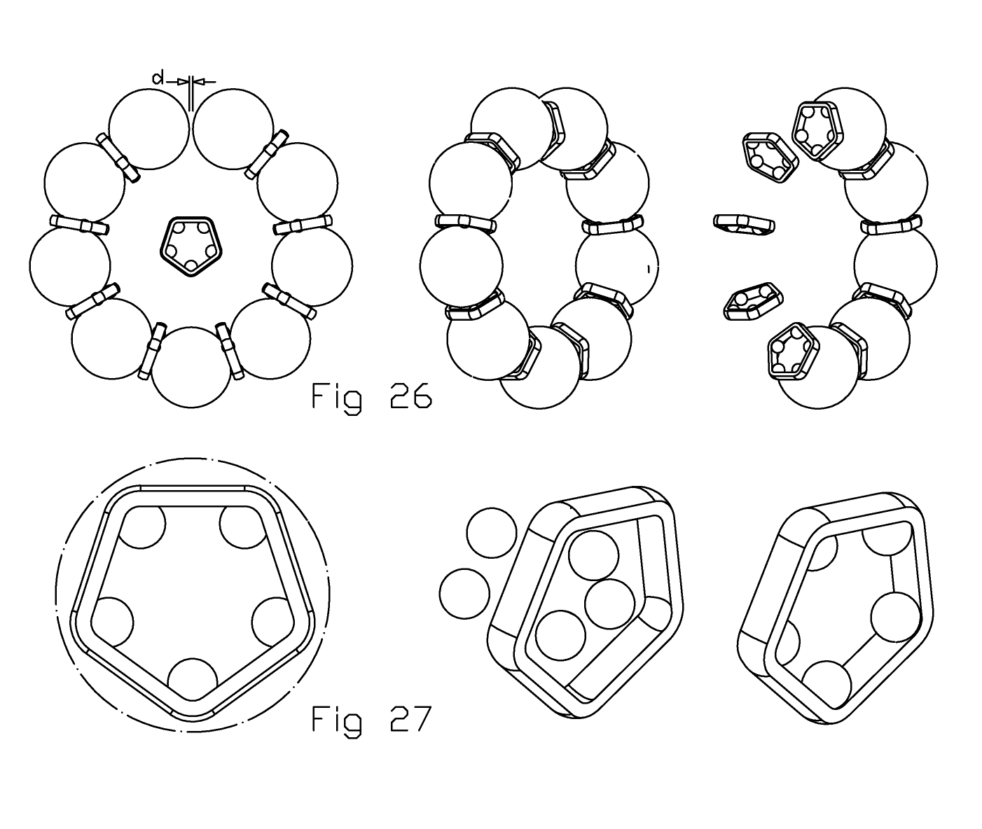

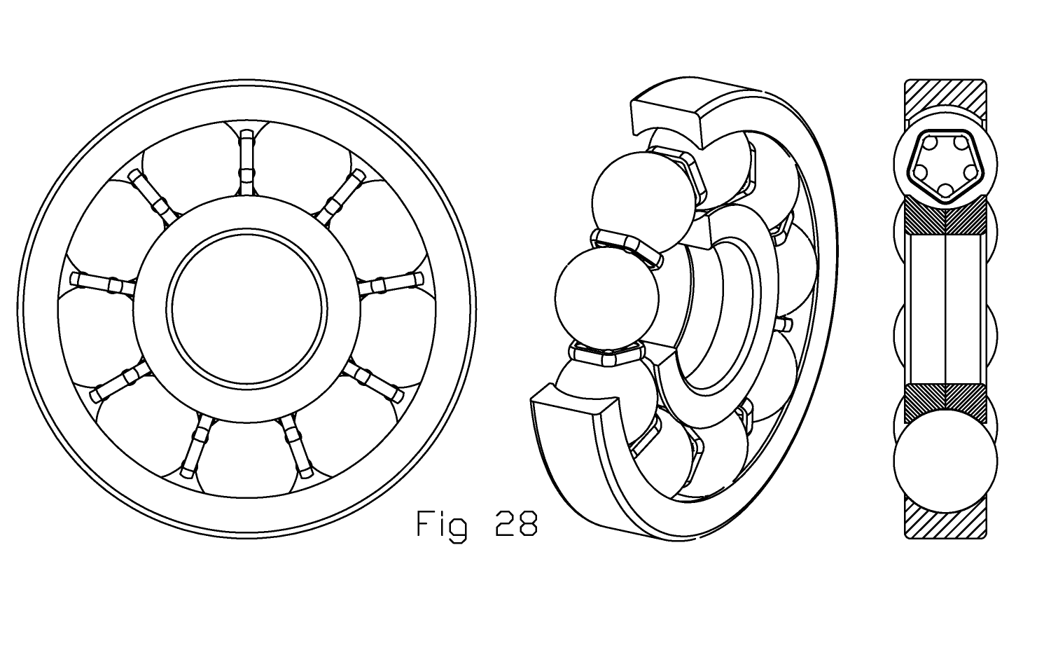

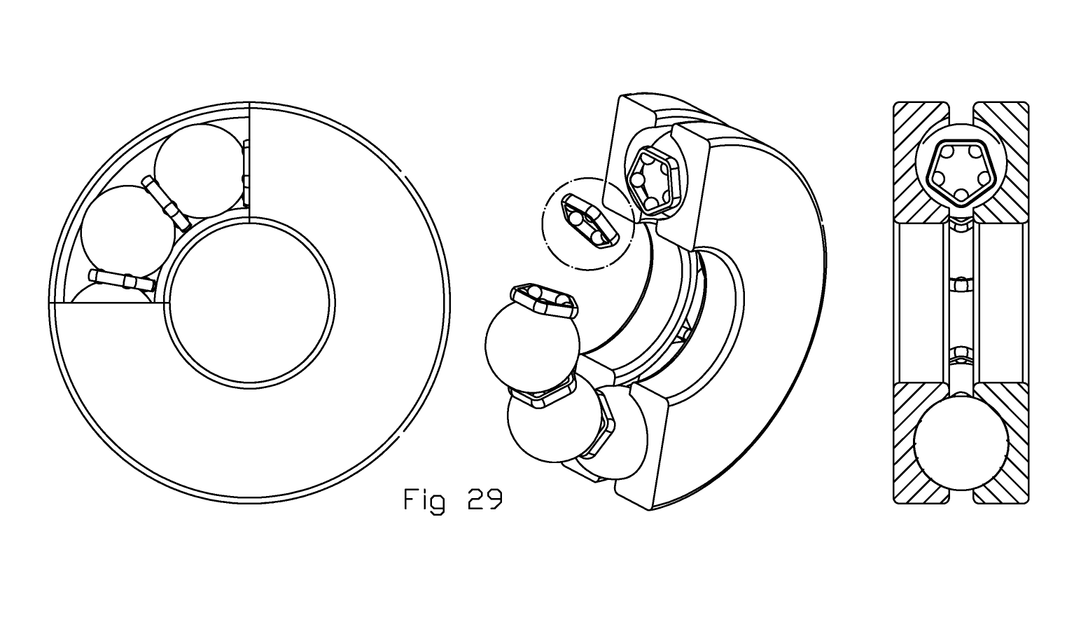

FIGS. 23 to 29 show the application of the above method in ball rolling bearings: between each pair of neighbor main rolling elements (the big balls) it is trapped a spacer comprising a cage and a few auxiliary rolling elements (the small balls); the small balls abut and roll on their neighbor big balls; the small balls abut also onto (and slide in) nests made on their cage. As in the sixth embodiment, the spacers with the auxiliary rolling elements prevent the neighbor big balls from contacting with each other, they also reduce the sliding friction inside the ball bearing.

A small elasticity of the cage is advantageous in the meaning that it allows the further approach (still without contact) of its two neighbor rolling elements without overloading the auxiliary rolling elements. I.e. with the proper design of the cage that holds the auxiliary rolling elements, the system is self-protected.

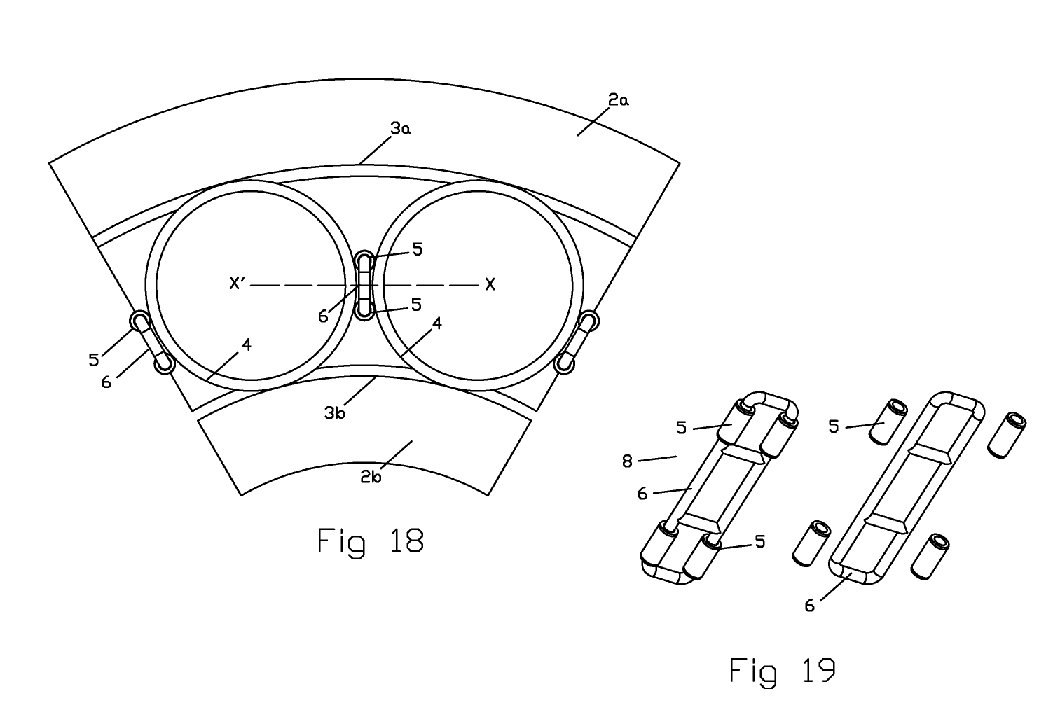

In a seventh embodiment, FIGS. 18 and 19, a “wire frame” and hollow needle rollers replace the cage and the conventional needle rollers of the sixth embodiment, further reducing the sliding friction by the smaller diameter “bearings” whereon each auxiliary needle roller is rotatably mounted/supported on its cage and slides. Alternatively each auxiliary needle roller can be integral with a coaxial shaft of smaller diameter (for instance, two small diameter pins extend at the ends of each auxiliary needle roller); the smaller diameter shafts (or pin extensions) are rotatably mounted in respective small diameter “bearing” on the cage reducing the sliding friction. I.e. the diameter of the bearing formed between an auxiliary needle roller (5) and its cage (6) can be substantially smaller than the diameter of the auxiliary needle roller (5), further reducing the sliding friction.

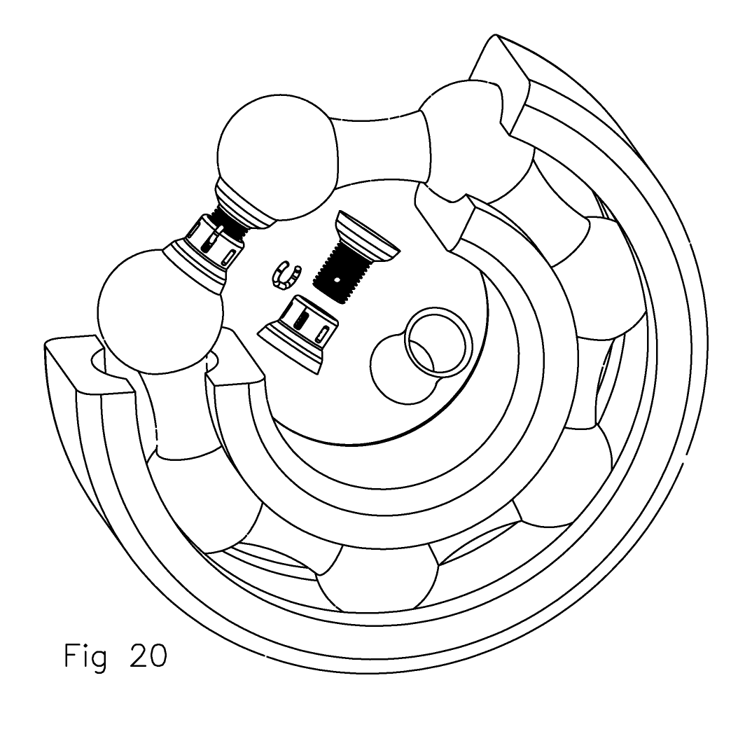

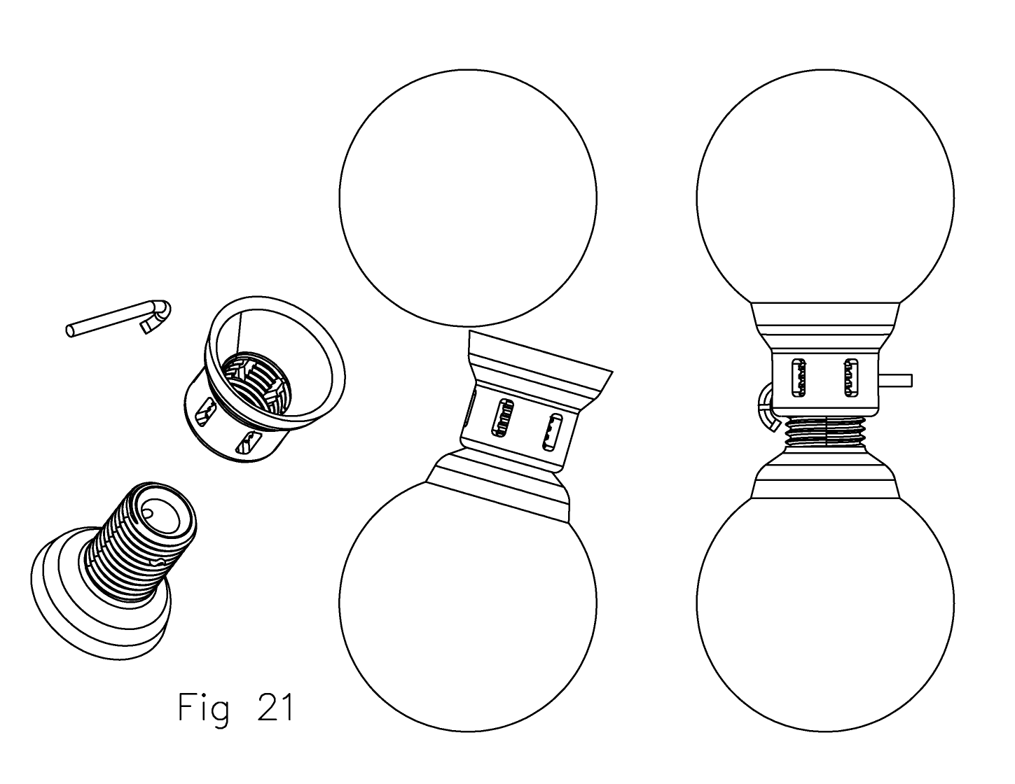

In an eighth embodiment, FIGS. 20 and 21, the spacers are inflexible/rigid (making the ball bearing appropriate, among others, for application wherein the entire ball bearing undergoes heavy accelerations). One spacer (master spacer) comprises two threaded parts and a clip key. Before the assembly the one threaded part is completely bolted into the other threaded part so that its active length is adequately small. After inserting/installing the balls and the spacers between the two bearing rings, the one part of the master spacer is unbolted from its other part as much as necessary to increase master spacer's active length. Then the clip key is inserted and secured properly to disable the unbolting of the two parts of the master spacer.

Although the invention has been described and illustrated in detail, the spirit and scope of the present invention are to be limited only by the terms of the appended claims.

What is claimed is:

1. A method for an improved rolling bearing,
the rolling bearing is comprising a first bearing ring (2a) having a first raceway (3a), a second bearing ring (2b) having a second raceway (3b), rolling elements (4) disposed between the first raceway (3a) and the second raceway (3b), each rolling element (4) is abutting onto both raceways (3a, 3b) and is transferring loads between them, the relative motion of the two raceways (3a, 3b) causes the rolling elements (4) to roll, each rolling element (4) neighboring with two other rolling elements (4),
the method is characterized in that:
an independent spacer (8) is being disposed between each pair of neighbor rolling elements (4),
each independent spacer (8) is comprising a cage (6) and auxiliary rolling elements (5),
the auxiliary rolling elements (5) of an independent spacer (8) abutting on the cage (6) of the independent spacer (8) and on two neighbor rolling elements (4) prevent the direct contact of neighbor rolling elements (4),
so that the sliding friction reduces and the load carrying capacity of the rolling bearing increases.

2. A method for an improved rolling bearing according claim 1 wherein each cage (6) is radially supported exclusively by its respective auxiliary rolling elements (5),
and wherein each auxiliary rolling element (5) is radially supported exclusively by its neighbor rolling elements (4) and/or its cage (6).

3. A rolling bearing comprising at least:
a first bearing ring (2a) having a first raceway (3a);
a second bearing ring (2b) having a second raceway (3b);
rolling elements (4) disposed between the first raceway (3a) and the second raceway (3b), each rolling element (4) is abutting onto both raceways (3a, 3b) and is transferring loads between them, the relative motion of the two raceways (3a, 3b) causes the rolling elements (4) to roll, each rolling element (4) neighboring with two other rolling elements (4);
a set of independent spacers, each independent spacer (8) preferably comprising a cage (6) and auxiliary rolling elements (5), each independent spacer (8) being trapped between, and supported on, a pair of neighbor rolling elements (4), each independent spacer (8) preventing its neighbor rolling elements (4) from coming into contact with each other.

4. A rolling bearing according claim 3, wherein:
each pair of neighbor rolling elements uses its own independent spacer.

5. A rolling bearing according claim 3, wherein:
the rolling bearing is a cylindrical roller bearing,
the rolling elements (4) are cylindrical rollers,
an outer bearing ring (2a) is extending substantially towards an inner bearing ring (2b), improving the rigidity of the outer bearing ring (2a), making unnecessary the use of additional side covers and providing grooves for sealing means.

6. A rolling bearing according claim 3, wherein:
the rolling bearing is a cylindrical roller bearing,
the rolling elements (4) are cylindrical rollers,
an auxiliary needle roller (5) is disposed, and supported, in an opening of the independent spacer (8), the auxiliary needle roller (5) rolls on two neighbor cylindrical rollers (4),
the independent spacer (8) supported on the two neighbor cylindrical rollers (4) prevents a center of the auxiliary needle roller (5) from leaving away a plane defined by rotation axes of the neighbor rollers (4).

7. A rolling bearing according claim 3, wherein:
the rolling bearing is a cylindrical roller bearing,
the rolling elements (4) are cylindrical rollers,
each independent spacer (8) comprises a pair of auxiliary needle rollers (5) and a cage (6), the cage (6) is holding the pair of auxiliary needle rollers (5) at a distance no more than a maximum, the auxiliary needle rollers (5) of the pair of auxiliary needle rollers being disposed at opposite sides of a plane defined by rotation axes (X, X′) of the neighbor rolling elements (4),
the pair of auxiliary needle rollers (5) engaged into the cage (6) and abutting/rolling on the pair of neighbor rolling elements (4) prevents the rolling elements (4) from coming into contact with each other.

8. A rolling bearing according claim 7, wherein:
the cage (6) is not contacting rolling elements (4).

9. A rolling bearing according claim 7, wherein:
the diameter of the bearing formed between an auxiliary needle roller (5) and its cage (6) is substantially smaller than the diameter of the auxiliary needle roller (5).

10. A rolling bearing according claim 7, wherein:
the cage (6) is a wire frame, the auxiliary needle rollers (5) are hollowed rollers, the wire frame passes through the hollowed auxiliary needle rollers and acts as their shaft.

11. A rolling bearing according claim 3, wherein:
the rolling bearing is a ball bearing,
the rolling elements (4) are balls,
the independent spacers (8) are substantially inflexible,
at least one independent spacer (8) is comprising more than one pieces to enable assembly of the ball bearing.

12. A rolling bearing according claim 3, wherein:
the rolling elements (4) are balls,
the auxiliary rolling elements (5) are balls,
between each pair of neighbor rolling elements (4) it is disposed an independent spacer (8) comprising a cage (6) and at least three auxiliary rolling elements (5), the cage (6) is holding the auxiliary rolling elements (5) of the set.

13. A rolling bearing according claim 3, wherein:
the rolling bearing is a ball bearing,
the rolling elements (4) are balls,
an auxiliary ball (5) is disposed in the cage (6) of the independent spacer (8) and is rolling on two neighbor balls (4), the cage (6) supported on the neighbor balls (4) is keeping the center of the auxiliary ball (5) close to the line connecting the two centers of the neighbor balls.

14. A rolling bearing according claim 3, wherein:
the rolling bearing is an axial, or thrust, ball bearing, the bearing rings are bearing washers.

15. A rolling bearing according claim 3, wherein:
the cage (6) has some degree of elasticity to prevent the excessive loading of the auxiliary rolling elements (5).

16. A rolling bearing according claim 3, wherein:
the rolling bearing is a cylindrical roller bearing,
the rolling elements are cylindrical rollers,
the independent spacers are pads disposed between neighbor cylindrical rollers, the shape of each pad is such that after assembly the pad remains trapped between its neighbor cylindrical rollers.

17. A rolling bearing according claim 3, wherein the rolling bearing is a ball bearing, the rolling elements (4) are balls, each independent spacer (8) is substantially longer than the distance between its neighboring balls (4) whereon it is supported.

18. A rolling bearing according claim 3, wherein:
the rolling bearing is a ball bearing, the rolling elements (4) are balls, the dimension of the independent spacer (8) along an axis of rotation of the ball bearing is smaller than a diameter of a ball (4).

19. A rolling bearing according claim 3, wherein:
the rolling bearing is a ball bearing, the rolling elements (4) are balls, the independent spacer (8) is adequately elastic to enable the assembly of the rolling bearing, the independent spacer (8) is adequately long and stiff to enable safe transfer of a centrifugal force on the two neighboring balls (4) without risk of disassembly.

20. A rolling bearing according claim 3, wherein:
the rolling bearing is a ball bearing, the independent spacers (8) are substantially inflexible, at least one independent spacer (8) is a master spacer comprising two pieces bolted to each other to enable a variable active length of the master spacer, so that during assembly the master spacer has a small active length allowing its insertion between two neighbor balls, after insertion the two pieces of the master spacer turn properly relative to each other until the active length of the master spacer to get as long as necessary with a key securing the two parts of the master spacer to each other.
